(19) United States
(12) Patent Application Publication
(10) Pub. No.: US 2004/0208737 A1
(43) Pub. Date: Oct. 21, 2004

(54) Backhoe/loader bucket design, attachment, and method for converting existing buckets

(76) Inventor: Brian A. Schmidtlein, Topeka, KS (US)

Correspondence Address: Michael B. McNeil, Liell & McNeil Attorneys PC, P.O. Box 2417, Bloomington, IN, 47402, US

(21) Appl. No.: 10/789,361

(22) Filed: Feb. 27, 2004

Related U.S. Application Data
(60) Provisional application No. 60/451,507, filed on Mar. 3, 2003.

(51) Int. Cl. B66C 23/00

(52) U.S. Cl. 414/724

(57) ABSTRACT

The arm and bucket of a backhoe loader have a first configuration in which a pair of stabilizer pads, which are attached to the bucket, are below a plane tangent to the four tires. However, the bottom of the bucket is mostly above that plane. This configuration corresponds to when the front wheels are elevated to stabilize the backhoe for digging operations. The arm and bucket have a second configuration, such as during loading or grading, in which the bottom of the bucket is in the plane of the tires, but the stabilizer pads are above that plane. The stabilizer pads are preferably serviceable in that they are removeably attached to the bucket. Accessory kits can also be utilized to retro-fit existing loader buckets.

### RELATION TO OTHER PATENT APPLICATION

This application claims the benefit of co-pending provisional patent application No. 60/451,507 filed Mar. 3, 2003, with the same title.

### TECHNICAL FIELD

This disclosure relates to the field of loader/backhoes.

### BACKGROUND

Loader/backhoes have a bucket on the front end for grading and loading, and a hoe at the opposing end, often referred to as “backhoe”. This backhoe is comprised of a boom (61 in FIG. 8) a stick (63) and an attachment (55). A typical configuration has a bucket as the attachment as is shown in FIG. 9. Other attachments include but are not limited to a compactor, a point breaker, and an auger. The disclosure is directed to a loader/backhoe having any of these attachments, and the phrase “backhoe” therefore includes but is not limited to the use of any of these attachments.

When using the backhoe, it is necessary and desirable to support the machine in a secure and static position. This is typically accomplished on the backhoe end of the machine by utilizing stabilizer logs that telescope or fold down to the pavement or ground, at the same time transferring most of the load from the wheels to the stabilizers. The front end bucket is also lowered to engage the ground sufficiently to transfer most of the front end load from the front wheels to the bucket. Consequently, the machine primarily rests on the front end bucket and the two rear stabilizers.

This presents a likelihood of significant damage to the pavement. It is common during the use of this heavy backhoe equipment for the front end bucket to gouge or damage the pavement or surface, sometimes even to the point of affecting the integrity of the pavement.

Moreover, utilizing the front end bucket as a support often creates a contact point or points between the bucket and the pavement that tend to be a distance from the bucket support arm (loader bucket arm 57). Sometimes this pavement contact point is as far away as the leading edge (71) of the bucket. In this situation the entire front end load rests on the front end of the bucket, transferring significant pressure to the bucket curl hydraulic cylinder(s) (67) that keep the bucket in the proper position. The space created (73) in this situation allows for instability of the bucket hydraulic cylinder(s) (67) causing the likelihood of significant wear and tear on that hydraulic cylinder(s) as the machine vibrates during backhoe use. Regardless of the contact point, the hydraulic cylinder(s) (67) often undergoes unnecessary and excessive wear and tear because this “vertical” instability.

“Horizontal” instability also occurs. It is common for the machine to move horizontally during use of the backhoe, whether on pavement or dirt.

Certain devices that purport to solve some of these problems are attachments that require the operator to get on and off the machine to put in place. They are also, therefore, less stable, less secure.

Consequently, it is an object of this disclosure to create a bucket design and device that is permanent, non-moving and provides both protection for the pavement and a more stable and secure front and contact with the pavement during backhoe operation without the need for “out of the seat” operator adjustments or installation, and while not interfering with the full range of motion of the front end bucket during grading or loading with the bucket. It is further the object of this disclosure to create a device and method to attach the same to existing buckets that is, relatively inexpensive, easy to install, very low maintenance, is useful with only minor modifications (across most brands of loaders/backhoes), and requires no special additional operator installation or attention during use.

Other objects and features of the disclosure will be apparent from the specification herein

### SUMMARY OF THE DISCLOSURE

In one aspect, a backhoe loader includes an arm and bucket that have a first configuration and a second configuration. In the first configuration, the arm and bucket are at least partially supported by a pair of stabilizer pads, but a bottom of the bucket is mostly above a plane tangent to four tires. In the second configuration, the bottom of the bucket is in the plane, but the stabilizer pads are above the plane.

In another aspect, a bucket for a backhoe loader includes a bottom adjacent a rear. A pair of stabilizer pads are attached to the rear adjacent opposite sides of the bucket, and also includes at least one arm connector. The stabilizer pads are above a tangent to the bottom of the bucket, and the arm connector is on a bucket side of a tangent to the stabilizer pads.

In still another aspect, a stabilizer pad accessory for attachment to a backhoe loader bucket includes a steel plate frame with a bucket attachment side oriented at an acute angle with respect to a stabilizer side. A stabilizer wear pad is replaceably attached to the stabilizer side.

### BRIEF DESCRIPTION OF THE DRAWINGS

FIG. 1 is a perspective view of the bucket design.

FIG. 2 is a side view of the attachment attached to on the rear side of an existing loader bucket when the bucket is fully curled and is in a support position for backhoe use.

FIG. 3 is a perspective view of the attachment.

FIG. 4 is a side view of the bucket with the attachment, showing use of the bucket, in the loading operation, and fully loaded, in a fully curled position.

FIG. 5 is a side view of the attachment shown on the bucket during the grading or loading position of the bucket.

FIG. 6 is a front view of the attachment.

FIG. 7 is a top view of the attachment.

FIG. 8 is a side view of the attachment.

FIG. 9 is a side view of a typical loader without the attachment, and having the stabilizers in the engaged position for backhoe use.

FIG. 10 is a side view of the loader with the attachment attached, with stabilizers in the engaged position, and with the bucket in a fully curled position with the front end of the machine now supported primarily by the attachment pads.

### DETAILED DESCRIPTION

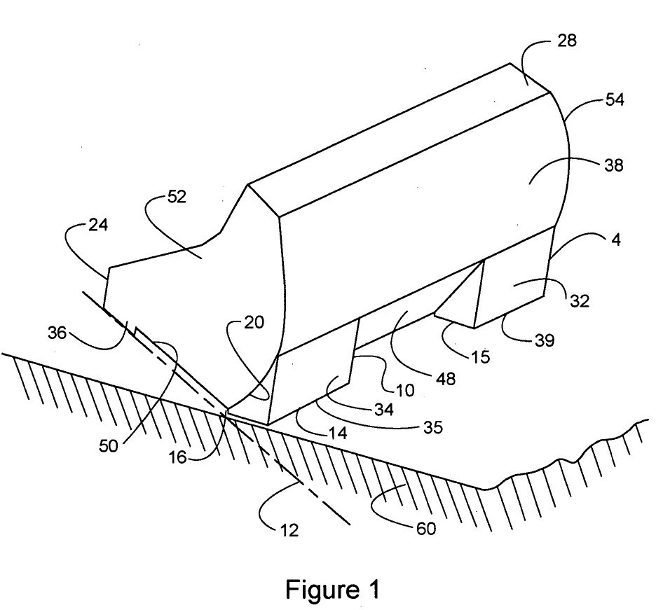

The design is shown in FIG. 1 in the preferred mode. The figure discloses a line 20 that represents a typical bucket rear design although some vary in shape. The bucket has a front 24 with front bottom piece 36, which typically reinforces the grading tip, and has rear 38, with bottom 50 and two sides 52, 54 and top 28.

The bucket is shown in the fully curled mode, with platform support 32 and 34 on either side of the recessed area 48, although the platform supports could extend from side to side. The recessed area allows for typically arm connections to the bucket.

The platform supports 10 and 4 have two sides 34 and 32, and a bottom 35 and 39, the bottoms have means for removably attaching friction pad means 14 and 15 as disclosed further herein in other modes of the disclosure. The platform bottom 34 and 39, with the bucket in the fully curled position, can touch the ground 60, but only comes close to, but does not quite touch or surpass (or touches insignificantly) the imaginary tangential line 12 drawn from the bottom-most portions of the bucket (touching points 16 and 36, although as will be seen in FIG. 4, this line can run essentially parallel to the bottom face 5 in FIG. 4 shown as 50 in FIG. 1.

Consequently, the intersection point 16 is shown between the platform bottom 35 and the bucket bottom 50. An intersection point similarly may exist at 17 with the pad.

The widths of the platform support sections 32 and 34 can be narrow enough, and located sufficiently toward the sides 52 and 54, so as to allow the bucket hydraulic arms to be connected at an arm connector in the recessed area 48.

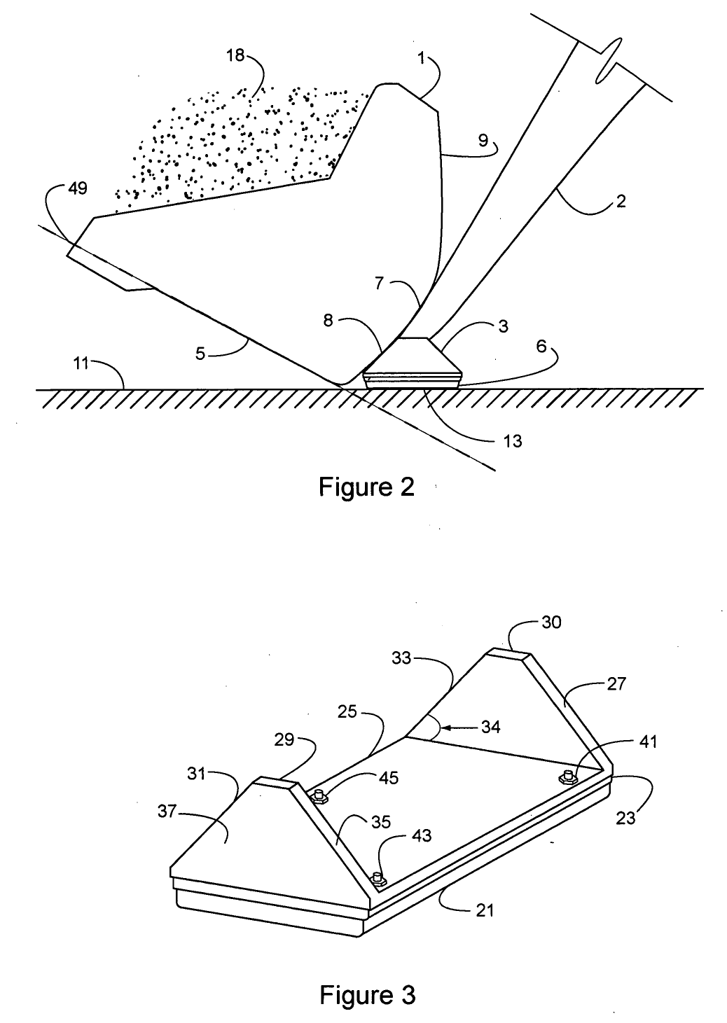

Existing buckets can be modified can be modified utilizing another embodiment of the attachment shown in FIGS. 2 and 3.

There the attachment (3) is shown in the preferred mode attached to the bucket (1) in FIG. 2, comprised of a pad 13 (preferably semi rigid non-abrasive composite material) having a contact surface for engaging the ground or pavement 11, removably attached to rigid plate means, and rigid support means affixing the rigid plate means to the backside of the bucket such that the pad contact surface can engage the ground when the bucket is essentially fully curled with the arms lowered, and does not interfere with the surface or ground during the full range of motion of the bucket otherwise.

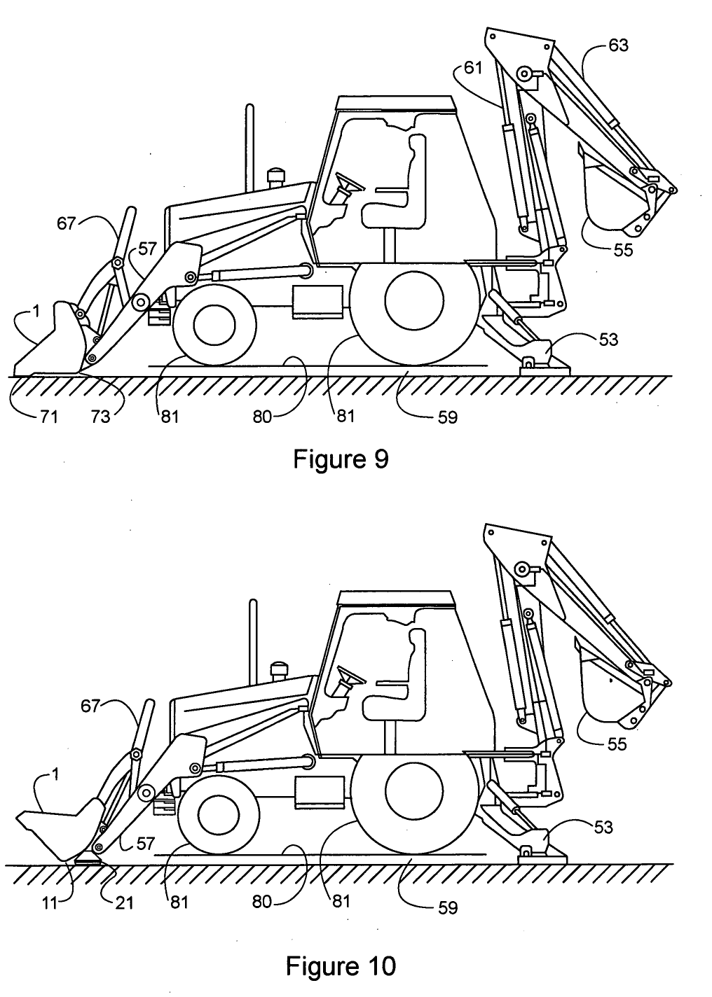

The typical bucket (1) has an upper rear portion (9) and a lower rear portion (7). The attachment (3) is, in the preferred mode, attached to the lower rear (7) of the bucket (or tangentially touches the bottom of the bucket from front to back, as previously discussed). The attachment (3) must in the preferred mode be placed on the lower rear of the bucket such that no part of the pads (21) touches or intersects that imaginary line (12) (referred to herein as the ‘in line’ requirement. The attachment (3) is welded to the rear of the bucket at (8), although other methods for attachment are envisioned, including bolting. The bucket (1) is rotatably attached to the loader bucket arm (2), and the rotational position of the bucket is controlled by a bucket hydraulic cylinder(s) (67 in FIG. 9). It should be noted that in FIG. 2 that bucket is shown in the fully curled position. i.e. the bucket is curled back as far as the hydraulics will allow. It is this position that defines the ‘fully engaged’ position for the flat pad mode, i.e. in this position, a flat stabilizer pad bottom will be fully engaged with the surface (11). Other surface shapes and stabilizer pads are envisioned for all modes of the disclosure, including a curved surface or curved pad surface (13), discussed below, that tends to allow a self leveling pad consistent with the particular equipment.

FIG. 2 shows the pads (21) in full contact with the ground (11) such that the pads (21) are providing the primary support for the front end loader so as to allow backhoe operation. Those skilled in the art will appreciate that the arm (2) is connected to the bucket (1) at a connector that is above, or on the bucket side of, a plane tangent to stabilizer pads 13.

FIG. 3 shows a perspective view of the preferred mode of the disclosure. A pad (21), comprised in the preferred mode of a rubber or composite material, is removably attached to rigid support means (25). These rigid support means are affixed to the back side of the bucket such that the pad contact surface (13 in FIG. 2) engages the ground when the bucket is essentially fully curled, and such that the pad (21) does not substantially interfere with the ground (11) during the full range of motion of the bucket during use. As used herein, “ground” and “surface” are the same and used interchangeably.

More specifically, the stabilizer pad (21), which is preferably slightly smaller than the plate (25), is removably attached to intermediate rigid steel plate (23) or other rigid essentially planar element (25). Affixing means can be any of several envisioned, but are shown in the preferred mode as nuts and bolts (41), (43) and (45). In the preferred mode intermediate plate (23) is sandwiched between rigid steel plate (25) and the pad (21). This allows for the use of existing and available pad assemblies that come pre-manufactured with the pad affixed to the steel plate (23).

Vertical rigid support extensions (29) and (30) are, in the preferred mode, located at or near the two opposing ends of the steel plate (25), perpendicular thereto, in essentially co-planar fashion to each other. The preferred mode suggests two, at or near the ends, but a single, wide, rigid support is also envisioned, as are multiple supports. It should be understood that these rigid extensions may be separately attached to the plate by welding or may be formed by bending the ends of the steel plate (25) to a perpendicular position. It should be further understood that the disclosure envisions any rigid extension means extending from the plate (25) so as to be attached to the rear of the bucket. The plate (25) and the support extensions (29) and (30) are in the preferred mode ½″ steel plate, although other thicknesses and materials may suffice, so long as the support is sufficiently rigid to support the expected weight of the bucket and equipment during use. Formation of the device is easily accomplished using an elongated steel plate and bending the two ends upwards to the preferred perpendicular position.

In FIG. 3, angled bucket attachment surfaces (31) and (33) are attached to the rear of the bucket (7) by welding or other affixing means. The angle (34) is determined by the shape of the rear of the bucket, and consequently can vary from manufacturer to manufacturer as the shapes of the buckets vary from manufacturer to manufacturer. The angle shown (42) is approximately 45 degrees in the preferred mode. For any particular bucket shape, it is important for the angle of the rear of the bucket, the device be attached such that the in-line requirement is met and such that the face of the pad fully engages the pavement surface when the bucket is fully curled and lowered. Those skilled in the art will appreciate that, in most instances, the attachment side of the steel support frame 25 will be at an acute angle with respect to pad attachment side. In some instances, depending upon the particular bucket shape, the bucket attachment side may be curved or include some other shape to accommodate some other rear shape of the bucket. Angled surfaces (27 and 35) are not as critical, but in the preferred mode, they are there not only to limit the amount of material in the device, but also can reduce any line of sight interference for the operator.

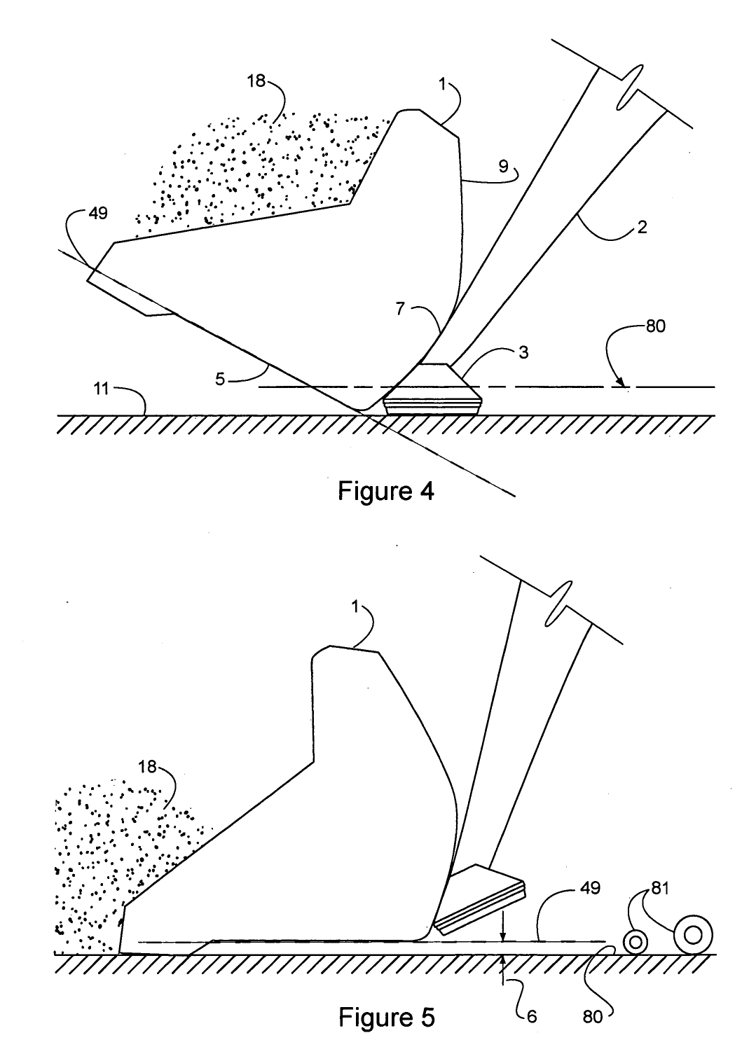

FIG. 4 shows the bucket with the device attached where the bucket is being used, i.e. the bucket is in operation, not the backhoe. In this figure, the bucket is shown as fully loaded, fully curled. In actual use of the bucket by the operator, and, because of the in-line requirement defined by imaginary line (12), there will nearly always be a minimum space (6) between the surface of the pad and the pavement surface, except when the bucket fully curled. FIG. 5 shows the bucket in operation again, during the grading or initial loading stage. It will be seen that because of the in-line requirement defined by the imaginary horizontal line (12), that the device does not interfere with the operation of the bucket in this position. When the arm and bucket are in the configuration shown in FIG. 5, the bottom of the bucket is in the plane 80 tangent to the tires 81, but the stabilizer pads are above that plane. Consequently, it will be seen than that both extreme bucket positions or stages have been shown (for most normal operations).

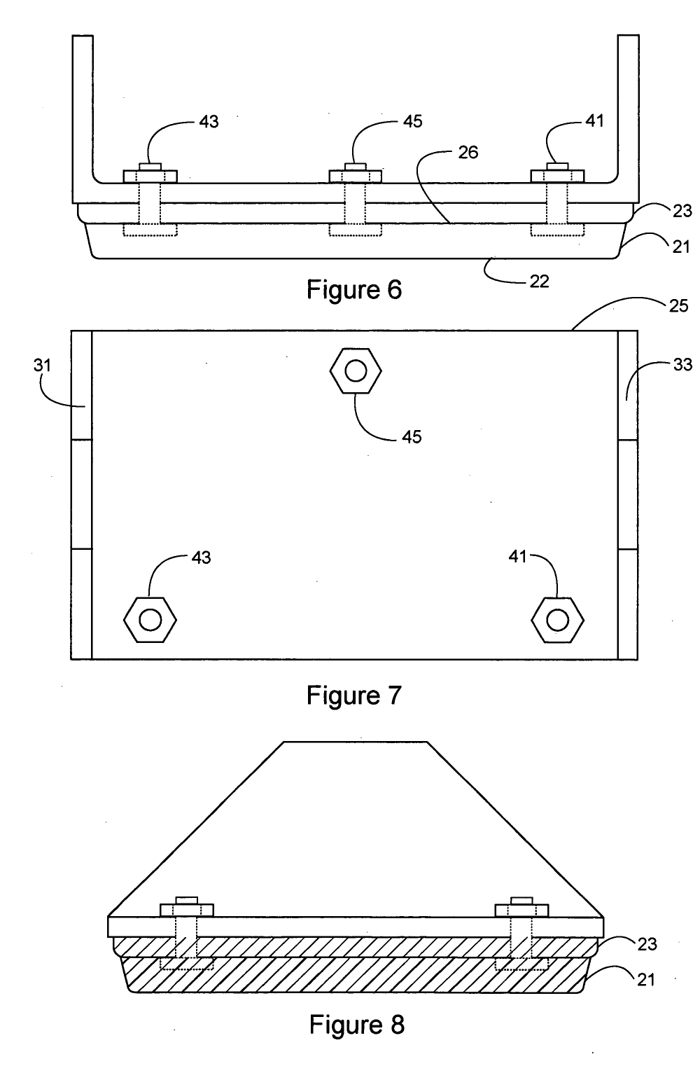

FIGS. 6, 7 and 8 show the front view, top view and side view of the device.

It should be understood that the pad (21), although shown in a planar form having a bottom face (22) and an opposing face (25), other shapes are envisioned including some circular or curved shape.

Industrial Applicability

To appreciate some of the advantages and features of the disclosure, the loader backhoe without the pads is shown in FIG. 9. The bucket (1) not being in a curled position is shown with bucket hydraulic cylinder(s) (67) and attached bucket arm (57). In order to set the machine up for backhoe operation so that the attachment (55) (which itself is attached to the stick (63) which itself is rotatably attached to the boom (61)), can be utilized, the machine must be stabilized. The bucket (1) is lowered making contact with the ground (71) and often leaving a space (73). The stabilizer arms (53 and 54) are lowered to the ground so as to transfer the load from the back tires primarily to the stabilizers (53 and 54) and in some cases this results in the tires even being raised leaving space (59).

Thus, it can be seen that to modify an existing bucket to the preferred design, a bucket pad assembly is created as disclosed with pad means removably attached. This bracket pad assembly should have a surface for removeably attaching pad means and having rigid means for affixing to the bucket. The bucket is placed in a fully curled position, the bracket is located at the rear, near the bottom, of the bucket such that the pad can touch the ground for support yet is only close to, but preferably not touching or surpassing (if touching, only insignificantly) the imaginary line 12, the bracket is then affixed (welded or bolted) to the bucket in place. The process is repeated for a bracket on the other side of the bucket, or they can be located and attached simultaneously. The assembly is then tested to assure that the bracket pad assembly does not interfere with the normal scooping or grading operation of the bucket by placing the bucket bottom on the ground to assure there is no or minimal, contact with the ground during scooping. Putting the bucket in the fully curled position should expose the face of the pad to the ground, and the pad can then be placed on the ground for support as the final test.

In utilizing the device, the bucket (1) is placed in a fully curled position exposing the attachment (3) (FIG. 10) to the surface at (11). The bucket arm (57) is thus lowered to bring the pads into contact with the surface until transferring sufficient load to the stabilize the front of the machine. It will be seen here that the support point (11) is much closer to the bucket arm (57) than the front edge of the bucket, as in point 71 in FIG. 9, thus allowing for far less movement in the bucket (1), which translates to far less “play” or movement in the bucket cylinder(s) (67). When the arm and the bucket are in the configuration shown in FIG. 10, the stabilizer pads 21 are below a plane 80 tangent to the four tires 81; however, the bottom of the bucket is mostly above that plane.

Because of the unique and simple design, it will be seen that the pads (21) allow for quick and easy operation by the operator. There is no need to get off the machine or put in place any devices. The device attachment also allows existing buckets to gain the same advantages. It involves simple installation, is relatively inexpensive to use, requires almost no maintenance except for the replacement of the pad, and in use requires no additional operator assistance. It will also be seen that the device can operator as a quick set ‘parking brake’ when an operator needs to quickly “park” the machine, simply by curling the bucket to its maximum position, and lowering the bucket arms to engage the ground with the pad. This simply provides an extra safety precaution, in the discretion and judgment of the operator, when the machine is not in use. It also helps to prevent horizontal movement of the machine when in use.

The attachment provides for all of these features while allowing for a full range of motion of the bucket without interference with the loading and grading operation of the bucket, and without the need of the operator to leave the cab to set or adjust the pads.

What is claimed is:

1. A backhoe loader comprising:
an arm and bucket having a first configuration in which a pair of pads are adjacent to and at least partially supporting the arm and bucket, but a bottom of the bucket is mostly above a plane tangent to four tires;
the arm and the bucket having a second configuration in which the bottom of the bucket is in the plane, but the pads are above the plane.

2. The backhoe loader of claim 1 wherein the pads are wear pads removeably attached to the bucket.

3. The backhoe loader of claim 1 wherein the bucket includes at least one arm connector, and the pads are attached to a rear adjacent opposite sides of the bucket;
the arm connector being on a bucket side of a tangent to the pads when the arm and bucket are in the first configuration.

4. The backhoe loader of claim 1 including a steel plate frame having a bucket attachment side oriented at an acute angle with respect to a stabilizer side; and
the pads each including a wear pad removeably attached to the stabilizer side.

5. The backhoe loader of claim 1 wherein an end of the arm is on a bucket side a plane tangent to the pads when the arm and bucket are in the first configuration.

6. The backhoe loader of claim 1 wherein the bucket is in a fully curled position with respect to the arm when the arm and bucket are in the first configuration.

7. A bucket for a backhoe loader comprising:
a bottom adjacent a rear;
a pair of pads attached to the rear adjacent opposite sides of the bucket, and also including at least one arm connector;
the pads being above a tangent to the bottom; and
the arm connector being on a bucket side of a tangent to the pads.

8. The bucket of claim 7 the wherein pads are wear pads removeably attached to the bucket.

9. The bucket of claim 7 including a steel plate frame having a bucket attachment side oriented at an acute angle with respect to a stabilizer side; and
the pads each include a wear pad removeably attached to the stabilizer side.

10. The bucket of claim 7 wherein the pads include wear pads that are attached to plates, which are removeably attached to the rear.

11. A stabilizer pad accessory for attachment to a backhoe loader bucket, the accessory comprising:
a steel plate frame having a bucket attachment side oriented at an acute angle with respect to a stabilizer side; and
a stabilizer wear pad removeably attached to said stabilizer side.

12. The stabilizer pad accessory of claim 11 including a support plate removeably attached to the steel plate frame on one side, and affixed to the wear pad on an opposite side.
